(19) United States
(12) Patent Application Publication
(10) Pub. No.: US 2026/0134559 A1
(43) Pub. Date: May 14, 2026

(54) METHOD FOR PERFORMING RELOCATION, POSITIONING DEVICE AND COMPUTER-READABLE STORAGE MEDIUM

(71) Applicant: HTC Corporation, Taoyuan City (TW)

(72) Inventor: Yan-Chen Chen, Taoyuan City (TW)

(73) Assignee: HTC Corporation, Taoyuan City (TW)

(21) Appl. No.: 18/943,852

(22) Filed: Nov. 11, 2024

(51) Int. Cl. G06T 7/579; G06V 10/60

(52) U.S. Cl. CPC G06T 7/579; G06V 10/60

(57) ABSTRACT

Embodiments of the disclosure provide a method for performing relocation, a positioning device, and a computer-readable storage medium. The method includes: executing SLAM to obtain a plurality of first keyframes, and sensing first environment sensing information corresponding to each first keyframe when obtaining each first keyframe; when the positioning device executes a relocation mechanism, sensing current environment sensing information, and finding at least one second keyframe among the plurality of first keyframes at least by comparing the current environment sensing information with the first environment sensing information corresponding to each first keyframe; and performing the relocation mechanism based on the at least one second keyframe.

### BACKGROUND

### Technical Field

The disclosure relates to a positioning mechanism, and particularly relates to a method for performing relocation, a positioning device, and a computer-readable storage medium.

### Description of Related Art

Simultaneous localization and mapping (SLAM) technology is a technology that allows a positioning device to simultaneously determine a location thereof and build an environmental map in an unknown environment. However, as the exploration range of the positioning device expands, the size of the SLAM map established by the positioning device also continues to grow.

In SLAM technology, relocation is a very important concept. The concept is that when the positioning device loses tracking of its own position, the device can re-determine the position thereof in the environment by comparing with the previously built map. However, when the size of the SLAM map is too large, the situation leads to problems such as extended relocation time, increased memory usage, and increased computing resource requirements, which is because feature matching and positioning calculations in huge map data require a large amount of computing resources.

### SUMMARY

In view of this, the disclosure provides a method for performing relocation, a positioning device, and a computer-readable storage medium, which can be used to solve the above technical problems.

Embodiments of the disclosure provide a method for performing relocation, executed by a positioning device applying simultaneous localization and mapping (SLAM), including: executing SLAM to obtain a plurality of first keyframes by the positioning device, and sensing first environment sensing information corresponding to each first keyframe when obtaining each first keyframe; when the positioning device executes a relocation mechanism, sensing current environment sensing information by the positioning device, and finding at least one second keyframe among the plurality of first keyframes at least by comparing the current environment sensing information with the first environment sensing information corresponding to each first keyframes; and performing the relocation mechanism by the positioning device based on the at least one second keyframe.

Embodiments of the disclosure provide a positioning device applying simultaneous localization and mapping (SLAM), including a storage circuit and a processor. The storage circuit stores a program code. The processor is coupled to the storage circuit and accesses the program code to: execute SLAM to obtain a plurality of first keyframes, and sense first environment sensing information corresponding to each of the first keyframes when obtaining each of the first keyframes; when executing a relocation mechanism, sense current environment sensing information by the positioning device, and find at least one second keyframe among the plurality of first keyframes at least by comparing the current environment sensing information with the first environment sensing information corresponding to each of the first keyframes; and perform the relocation mechanism based on the at least one second keyframe.

Embodiments of the disclosure provide a computer-readable storage medium. The computer-readable storage medium records an executable computer program, and the executable computer program is loaded by a positioning device applying simultaneous localization and mapping (SLAM) to perform steps as follows: execute SLAM to obtain a plurality of first keyframes, and sense first environment sensing information corresponding to each of the first keyframes when obtaining each of the first keyframes; when executing a relocation mechanism, sense current environment sensing information by the positioning device, and find at least one second keyframe among the plurality of first keyframes at least by comparing the current environment sensing information with the first environment sensing information corresponding to each of the first keyframes; and perform the relocation mechanism based on the at least one second keyframe.

### BRIEF DESCRIPTION OF THE DRAWINGS

FIG. 1 is a schematic diagram of a positioning device according to an embodiment of the disclosure.

FIG. 2 is a flow chart of a method for performing relocation according to an embodiment of the disclosure.

### DESCRIPTION OF THE EMBODIMENTS

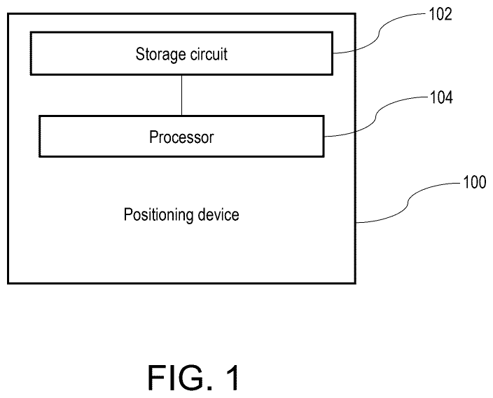

Please refer to FIG. 1, which is a schematic diagram of a positioning device according to an embodiment of the disclosure. In different embodiments, a positioning device 100 may be implemented as various devices that can apply SLAM, for example, such as service robots, industrial robots, drones, self-driving cars, head-mounted displays (HMD) used to provide reality services (such as augmented reality, virtual reality, and mixed reality), and mobile phones, but the disclosure is not limited thereto.

In FIG. 1, the positioning device 100 includes a storage circuit 102 and a processor 104.

The storage circuit 102 is, for example, any type of fixed or removable random access memory (RAM), read-only memory (ROM), flash memory, hard disk, or other similar device, or a combination of the devices, and can be used to record multiple program codes or modules.

The processor 104 is coupled to the storage circuit 102 and may be a general purpose processor, a special purpose processor, a conventional processor, a digital signal processor, multiple microprocessors, one or more microprocessors combining a digital signal processor core, a controllers, a microcontroller, an application specific integrated circuit (ASIC), a field programmable gate array (FPGA), any other kind of integrated circuit, a state machine, an advanced RISC Machine (ARM)-based processor, and similar products.

In an embodiment of the disclosure, the processor 104 may access the modules and program codes recorded in the storage circuit 102 to implement a method for performing relocation proposed by the disclosure, and details thereof are described in detail below.

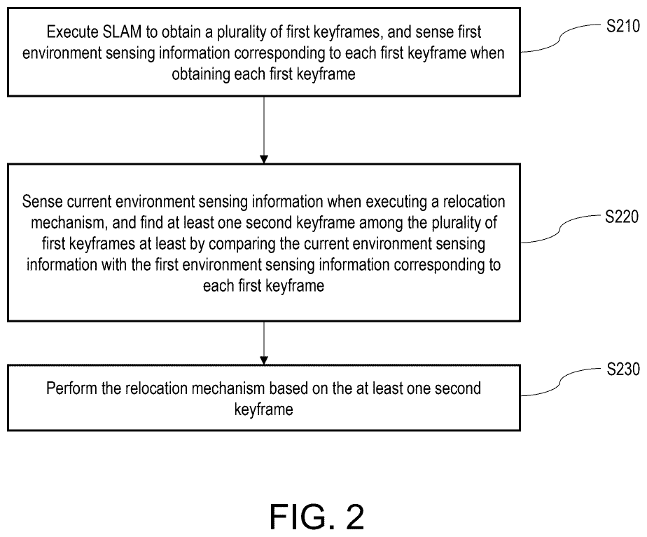

Please refer to FIG. 2, which is a flow chart of the method for performing relocation according to an embodiment of the disclosure. The method of this embodiment may be executed by the positioning device 100 in FIG. 1, and details of each step in FIG. 2 will be described below with components shown in FIG. 1.

In Step S210, the processor 104 executes SLAM to obtain a plurality of first keyframes, and senses first environment sensing information corresponding to each first keyframe when obtaining each first keyframe.

Generally speaking, keyframes in SLAM technology are some representative image frames selected and saved by the SLAM system. The image frames contain rich environmental feature information and may be used to record observations of a camera (such as tracking camera) or a positioning device at specific locations. Associated with each keyframe is the pose of the camera (which may be characterized in a form of six-degree-of-freedom) and the extracted map points. The keyframe is not necessarily the image frame at each moment, but is more likely to be the image frame selected according to a certain strategy. For example, when the pose of the camera and/or the pose of the positioning device 100 changes significantly or when the environmental features change significantly, the corresponding image frame may be recorded as a keyframe. The keyframes constitute the map in the SLAM system and are used to assist the system in performing relocation to restore the pose of the positioning device 100 during the subsequent positioning process.

Based on the above, each first keyframe in Step S210 may be understood as a keyframe collected during the positioning device 100 performing SLAM, but the disclosure is not limited thereto.

In an embodiment, assuming that the positioning device 100 performs SLAM in a specific field, then the positioning device 100 may capture image frames with a camera (such as a tracking camera) of the positioning device 100 while moving around in the specific field, and part of the image frames may be recorded as a first keyframe, but the disclosure is not limited thereto.

In an embodiment of the disclosure, the processor 104 may sense first environment sensing information corresponding to each first keyframe when obtaining each first keyframe.

In an embodiment of the disclosure, the first environment sensing information corresponding to each first keyframe includes at least one of non-contact force information and ambient light information correspondingly sensed by the positioning device 100 when obtaining each first keyframe. In the embodiment, the non-contact force information can also be referred to as the information of force at a distance, but the disclosure is not limited thereto.

In an embodiment, the non-contact force information may include at least one of a magnetic force direction, a magnetic force strength, a direction of gravity, and a non-contact force angle, and the non-contact force angle includes an angle between the magnetic force direction and the direction of gravity.

In an embodiment, the ambient light information may include an ambient brightness and an exposure parameter.

In an embodiment, the processor 104 may control a relevant environmental sensor to sense the corresponding environment sensing information when obtaining the image frames captured by the camera in the specific field. Afterward, if the captured image frame is determined to be one of the first keyframes (hereinafter referred to as a first frame), the processor 104 may then determine the environment sensing information corresponding to the first frame as the corresponding first environment sensing information, but the disclosure is not limited thereto.

In different embodiments, the environmental sensor may, for example, be coupled to the processor 104, and may be implemented as at least one of an e-compass, an inertial measurement unit (IMU), and an optical sensor, but the disclosure is not limited thereto.

In an embodiment in which the environmental sensor includes the e-compass, the environment sensing information corresponding to the first frame includes, for example, the magnetic force direction and/or the magnetic force strength, in which the magnetic force direction is, for example, a magnetic field direction measured by the e-compass, and the magnetic force strength is, for example, a magnetic field strength measured by the e-compass.

In an embodiment in which the environmental sensor includes the e-compass and the inertial measurement unit, the environment sensing information corresponding to the first frame includes, for example, at least one of the magnetic force direction, the magnetic force strength, a direction of gravity, and a non-contact force angle. In an embodiment, the non-contact force angle is, for example, an angle between one of the magnetic force direction and the direction of gravity relative to the other one of the magnetic force direction and the direction of gravity.

In an embodiment in which the environmental sensor includes the optical sensor, the environment sensing information corresponding to the first frame includes, for example, an ambient brightness and an exposure parameter.

In an embodiment in which the environmental sensor includes the e-compass, the inertial measurement unit, and the optical sensor, the environment sensing information corresponding to the first frame includes, for example, at least one of the magnetic force direction, the magnetic force strength, the direction of gravity, the non-contact force angle, the ambient brightness, and the exposure parameter.

In other embodiments, the environmental sensor may further include sensors with other environment sensing functions and is not limited to the components mentioned above.

In Step S220, when executing a relocation mechanism, the processor 104 senses current environment sensing information, and finds at least one second keyframe among the plurality of first keyframes at least by comparing current environment sensing information with the first environment sensing information corresponding to each first keyframe.

In some embodiments, when a device applying the SLAM system loses tracking for some reason and is unable to determine a current pose thereof, the device may execute the relocation mechanism. Generally speaking, when executing the relocation mechanism, the device may match a currently observed image frame (hereinafter referred to as a current frame) with a recorded keyframe. Specifically, the device extracts feature points from the current frame and uses feature matching technology to find a keyframe with similar feature points. Afterward, the device may calculate a pose transformation of the current camera relative to the matched keyframe based on the geometric relationship between the matched feature points. In this way, the device can re-determine the current accurate position based on the location of the keyframe, thereby restoring positioning and continuing normal operation.

However, as the time for the positioning device 100 to run SLAM increases, the quantity of recorded first keyframes increases accordingly. In this case, when the positioning device 100 executes the relocation mechanism, the feature points of the current frame need to be compared with a large quantity of first keyframes, which may reduce the efficiency of SLAM.

Therefore, instead of directly comparing the current frame with the plurality of first keyframes, the processor 104 may first select at least one second keyframe among the first keyframes through Step S220, and perform the relocation mechanism based on the at least one second keyframe of a smaller quantity. In this way, the efficiency of SLAM can be improved.

Specifically, when the positioning device 100 needs to perform the relocation mechanism, the processor 104 may, for example, control the environmental sensor to sense the current environment sensing information as the current environment sensing information considered in Step S220.

In different embodiments, the current environment sensing information may include at least one of the magnetic force direction, the magnetic force strength, the direction of gravity, the non-contact force angle, the ambient brightness, and the exposure parameter according to the types of the environmental sensor, but the disclosure is not limited thereto.

After obtaining the current environment sensing information, the processor 104 may find at least one second keyframe among the plurality of first keyframes at least by comparing the current environment sensing information with the first environment sensing information corresponding to each first keyframe.

In an embodiment, in response to determining that the first environment sensing information corresponding to the first frame in the first keyframe matches the current environment sensing information, the processor 104 may determine that the first frame belongs to the at least one second keyframe. On the other hand, in response to determining that the first environment sensing information corresponding to the first frame does not match the current environment sensing information, the processor 104 may determine that the first frame does not belong to the at least one second keyframe.

From another point of view, the concept of determining that the first frame belongs to the at least one second keyframe may be understood as determining that the first frame is one of the at least one second keyframe, that is, the first frame may be used to perform the subsequent relocation mechanism. On the contrary, the concept of determining that the first frame does not belong to the at least one second keyframe may be understood as determining that the first frame is not one of the at least one second keyframe, that is, the first frame is not used to execute the subsequent relocation mechanism, but the disclosure is not limited thereto.

In an embodiment, in response to determining that the difference between the first environment sensing information corresponding to the first frame and the current environment sensing information is within an error range, the processor 104 may determine that the first environment sensing information corresponding to the first frame matches the current environment sensing information. On the other hand, in response to determining that the difference between the first environment sensing information corresponding to the first frame and the current environment sensing information is not within the error range, the processor 104 may determine that the first environment sensing information corresponding to the first frame does not match the current environment sensing information.

For example, it is assumed that the first environment sensing information corresponding to the first frame is the corresponding magnetic force direction (hereinafter referred to as A1) when obtaining the first frame, and the current environment sensing information is the magnetic force direction (hereinafter referred to as B1) currently sensed by the positioning device 100. In this case, if the difference between the magnetic force direction A1 and the magnetic force direction B1 (for example, an angle between the magnetic force direction A1 and the magnetic force direction B1) is within the error range (such as a certain preset angle range), then, the processor 104 may determine, for example, that the first environment sensing information corresponding to the first frame matches the current environment sensing information. On the contrary, if the difference between the magnetic force direction A1 and the magnetic force direction B1 is not within the error range, then the processor 104 may determine, for example, that the first environment sensing information corresponding to the first frame does not match the current environment sensing information.

For another example, it is assumed that the first environment sensing information corresponding to the first frame is the corresponding magnetic force strength (hereinafter referred to as A2) when obtaining the first frame, and the current environment sensing information is the magnetic force strength (hereinafter referred to as for B2) currently sensed by the positioning device 100. In this case, if the difference between the magnetic force strength A2 and the magnetic force strength B2 (for example, a strength difference between the magnetic force strength A2 and the magnetic force strength B2) is within the error range (such as a certain preset strength range), then the processor 104 may determine, for example, that the first environment sensing information corresponding to the first frame matches the current environment sensing information. On the contrary, if the difference between the magnetic force strength A2 and the magnetic force strength B2 is not within the error range, then the processor 104 may determine, for example, that the first environment sensing information corresponding to the first frame does not match the current environment sensing information.

For still another example, it is assumed that the first environment sensing information corresponding to the first frame is the corresponding non-contact force angle (hereinafter referred to as A3) when obtaining the first frame, and the current environment sensing information is the non-contact force angle (hereinafter referred to as B3) currently sensed by the positioning device 100. In this case, if the difference between the non-contact force angle A3 and the non-contact force angle B3 (for example, an angular difference between the non-contact force angle A3 and the non-contact force angle B3) is within the error range (such as a certain preset angle range), then the processor 104 may determine, for example, that the first environment sensing information corresponding to the first frame matches the current environment sensing information. On the contrary, if the difference between the non-contact force angle A3 and the non-contact force angle B3 is not within the error range, then the processor 104 may determine, for example, that the first environment sensing information corresponding to the first frame does not match the current environment sensing information.

For other aspects of environment sensing information (such as the ambient brightness and the exposure parameter), people having ordinary skills in the art should be able to deduce corresponding matching determination methods based on the above description, so details will not be repeated here.

In some embodiments, assuming that the considered environment sensing information includes multiple aspects at the same time, the processor 104 may first perform a weighted combination based on the aspects to obtain a corresponding value (which may be understood as a score), and the above-mentioned matching determination is performed based on the value.

For example, it is assumed that the first environment sensing information corresponding to the first frame is the magnetic force direction A1, the magnetic force strength A2, and the non-contact force angle A3 corresponding to the first frame when obtaining the first frame, and the current environment sensing information is the magnetic force direction B1, the magnetic force strength B2, and the non-contact force angle B3 currently sensed by the positioning device 100. In this case, the processor 104 may, for example, perform a weighted combination based on the magnetic force direction A1, the magnetic force strength A2, and the non-contact force angle A3 to determine the corresponding value (hereinafter referred to as a value N1), and then perform the same weighted combination based on the magnetic force direction B1, the magnetic force strength B2, and the non-contact force angle B3 to determine the corresponding value (hereinafter referred to as a value N2). Afterward, if the difference between the value N1 and the value N2 is within the error range (such as a preset value range), then the processor 104 may determine, for example, that the first environment sensing information corresponding to the first frame matches the current environment sensing information. On the contrary, if the difference between the value N1 and the value N2 is not within the error range, then the processor 104 may determine, for example, that the first environment sensing information corresponding to the first frame does not match the current environment sensing information.

When the considered environment sensing information includes aspects of other combinations, persons with ordinary knowledge in the art should be able to deduce the corresponding matching determination methods based on the above description, so details will not be repeated here.

In Step S230, the processor 104 performs the relocation mechanism based on the at least one second keyframe.

In an embodiment, the processor 104 may, after obtaining the current frame corresponding to the current environment sensing information, determine whether one of the at least one second keyframe (hereinafter referred to as a second frame) matches the current frame.

In an embodiment, the processor 104 may determine a similarity between a plurality of first feature points in the second frame and a plurality of reference feature points in the current frame. In response to determining that the similarity is higher than a similarity threshold, the processor 104 may determine that the second frame matches the current frame. On the other hand, in response to determining that the similarity is not higher than the similarity threshold, the processor 104 may determine that the second frame does not match the current frame.

In different embodiments, the processor 104 may be based on, for example, scale-invariant feature transform (SIFT), speeded-up robust features (SURF), random sample consensus (RANSAC), or other similar feature matching algorithms, to determine the similarity, but the disclosure is not limited thereto.

In an embodiment, in response to determining that the second frame matches the current frame, the processor 104 may re-determine the current accurate position of the positioning device 100 based on the position of the second frame, thereby restoring positioning and continuing normal operation.

It may be seen from the above that since the quantity of the selected second keyframes is less than the first keyframes, the processor 104 can find the second frame matching the current frame with better efficiency. Thereby, the efficiency of the positioning device 100 in executing the relocation mechanism can be improved.

In some implementations, the method proposed by the embodiment of the disclosure can provide better efficiency improvement effect when the area of the specific field is larger (for example, not less than 900 square meters) and/or the quantity of the first keyframes is larger (for example, not less than 300).

On the other hand, in response to determining that the second frame does not match the current frame, the processor 104 may continue to search for other frames matching the current frame in other second keyframes, but the disclosure is not limited thereto.

The disclosure further provides a computer-readable storage medium. The computer-readable storage medium is formed by a quantity of program commands (for example, a setup program command and a deploy program command) embodied therein. The program commands may be loaded into the positioning device 100 and executed therein to perform the above method and the functions of the positioning device 100.

In summary, the technical solution proposed by the embodiments of the disclosure can select a smaller quantity of the second keyframes among the first keyframes by comparing the environment sensing information, and then execute the relocation mechanism based on the second keyframe. In this way, the amount of memory and computation required to execute the relocation mechanism can be reduced, thereby the efficiency of relocation is improved.

Although the disclosure has been disclosed above through embodiments, the embodiments are not intended to limit the disclosure. Persons with ordinary knowledge in the relevant technical field may make some modifications and modifications without departing from the spirit and scope of the disclosure. Therefore, the protection scope of the disclosure shall be determined by the appended claims.

What is claimed is:

1. A method for performing relocation, executed by a positioning device applying simultaneous localization and mapping (SLAM), comprising:
executing, by the positioning device, SLAM to obtain a plurality of first keyframes, and sensing, by the positioning device, first environment sensing information corresponding to each of the first keyframes when obtaining each of the first keyframes;
in response to the positioning device executing a relocation mechanism, sensing, by the positioning device, current environment sensing information, and finding, by the positioning device, at least one second keyframe among the plurality of first keyframes at least by comparing the current environment sensing information with the first environment sensing information corresponding to each of the first keyframes; and
performing, by the positioning device, the relocation mechanism based on the at least one second keyframe.

2. The method as claimed in claim 1, wherein the first environment sensing information corresponding to each of the first keyframes comprises at least one of non-contact force information and ambient light information correspondingly sensed by the positioning device when obtaining each of the first keyframes.

3. The method as claimed in claim 2, wherein the non-contact force information comprises at least one of a magnetic force direction, a magnetic force strength, a direction of gravity, and a non-contact force angle, and the non-contact force angle comprises an angle between the magnetic force direction and the direction of gravity.

4. The method as claimed in claim 2, wherein the ambient light information comprises an ambient brightness and an exposure parameter.

5. The method as claimed in claim 1, wherein the plurality of first keyframes are associated with a specific field where the positioning device is located, and an area of the specific field is not less than 900 square meters.

6. The method as claimed in claim 1, wherein a quantity of the plurality of first keyframes is not less than 300.

7. The method as claimed in claim 1, wherein sensing the current environment sensing information comprises:
sensing the current environment information at least by an environmental sensor of the positioning device.

8. The method as claimed in claim 1, wherein finding the at least one second keyframe among the plurality of first keyframes at least by comparing the current environment sensing information with the first environment sensing information corresponding to each of the first keyframes comprises:
in response to determining that first environment sensing information corresponding to a first frame in the plurality of first keyframes matches the current environment sensing information, determining that the first frame belongs to the at least one second keyframe; and
in response to determining that the first environment sensing information corresponding to the first frame does not match the current environment sensing information, determining that the first frame does not belong to the at least one second keyframe.

9. The method as claimed in claim 8, comprising:
in response to determining that a difference between the first environment sensing information corresponding to the first frame and the current environment sensing information is within an error range, determining that the first environment sensing information corresponding to the first frame matches the current environment sensing information; and
in response to determining that the difference between the first environment sensing information corresponding to the first frame and the current environment sensing information is not within the error range, determining that the first environment sensing information corresponding to the first frame does not match the current environment sensing information.

10. A positioning device applying simultaneous localization and mapping (SLAM), comprising:
a non-transitory storage circuit storing a program code;
a processor coupled to the non-transitory storage circuit and configured to access the program code to:
execute SLAM to obtain a plurality of first keyframes, and sense first environment sensing information corresponding to each of the first keyframes when obtaining each of the first keyframes;
in response to executing a relocation mechanism, sense current environment sensing information by the positioning device, and find at least one second keyframe among the plurality of first keyframes at least by comparing the current environment sensing information with the first environment sensing information corresponding to each of the first keyframes; and
perform the relocation mechanism based on the at least one second keyframe.

11. The positioning device as claimed in claim 10, wherein the first environment sensing information corresponding to each of the first keyframes comprises at least one of non-contact force information and ambient light information correspondingly sensed by the positioning device when obtaining each of the first keyframes.

12. The positioning device as claimed in claim 11, wherein the non-contact force information comprises at least one of a magnetic force direction, a magnetic force strength, a direction of gravity, and a non-contact force angle, and the non-contact force angle comprises an angle between the magnetic force direction and the direction of gravity.

13. The positioning device as claimed in claim 11, wherein the ambient light information comprises an ambient brightness and an exposure parameter.

14. The positioning device as claimed in claim 10, wherein the plurality of first keyframes are associated with a specific field where the positioning device is located, and an area of the specific field is not less than 900 square meters, or a quantity of the plurality of first keyframes is not less than 300.

15. The positioning device as claimed in claim 10, further comprising an environmental sensor coupled to the processor, and the processor is configured to:
sense the current environment information at least by the environmental sensor of the positioning device.

16. The positioning device as claimed in claim 10, wherein the processor is configured to:
in response to determining that first environment sensing information corresponding to a first frame in the plurality of first keyframes matches the current environment sensing information, determine that the first frame belongs to the at least one second keyframe; and
in response to determining that the first environment sensing information corresponding to the first frame does not match the current environment sensing information, determine that the first frame does not belong to the at least one second keyframe.

17. A non-transitory computer-readable storage medium, wherein the non-transitory computer-readable storage medium records an executable computer program, and the executable computer program is loaded by a positioning device applying simultaneous localization and mapping (SLAM) to:
execute SLAM to obtain a plurality of first keyframes, and sense first environment sensing information corresponding to each of the first keyframes when obtaining each of the first keyframes;
in response to executing a relocation mechanism, sense current environment sensing information by the positioning device, and find at least one second keyframe among the plurality of first keyframes at least by comparing the current environment sensing information with the first environment sensing information corresponding to each of the first keyframes; and
perform the relocation mechanism based on the at least one second keyframe.
